(19) United States
(12) Patent Application Publication
(10) Pub. No.: US 2025/0310982 A1
(43) Pub. Date: Oct. 2, 2025

(54) IMPLICIT CROSS-LINK INTERFERENCE REPORTING IN SUB-BAND FULL DUPLEX

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 18/623,475

(22) Filed: Apr. 1, 2024

(51) Int. Cl. H04W 72/541; H04L 5/00; H04L 5/14; H04W 24/10

(52) U.S. Cl. CPC H04W 72/541; H04L 5/0051; H04L 5/14; H04W 24/10

(57) ABSTRACT

Methods, systems, and devices for wireless communications are described. A user equipment (UE) may receive first control signaling indicating a set of channel measurement resources (CMRs) including one or more CMRs and a set of interference measurement resources (IMRs) including a plurality of IMRs, the set of CMRs and the set of IMRs corresponding to a first channel state information (CSI) report, and a CMR corresponding to the IMRs of the plurality of IMRs. The UE may perform one or more CSI measurements via the set of CMRs according to the first control signaling. The UE may perform a plurality of CLI measurements via the set of IMRs, wherein the plurality of IMRs corresponds to a plurality of UEs. The UE may transmit a CSI report comprising one or more CSI metrics.

### FIELD OF TECHNOLOGY

The following relates to wireless communications, including implicit cross-link interference reporting in sub-band full duplex.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support implicit cross-link interference reporting in sub-band full duplex. For example, the described techniques provide for receiving, at a user equipment (UE), first control signaling indicating a set of channel measurement resources (CMRs) including one or more CMRs and a set of interference measurement resources (IMRs) including a plurality of IMRs, the set of CMRs and the set of IMRs corresponding to a first channel state information (CSI) report, and a CMR corresponding to the IMRs of the plurality of IMRs. The UE may perform one or more CSI measurements via the set of CMRs according to the first control signaling. The UE may perform a plurality of cross-link interference (CLI) measurements via the set of IMRs, wherein the plurality of IMRs corresponds to a plurality of UEs. The UE may transmit a CSI report comprising one or more CSI metrics, a CSI metric based at least in part on the one or more CSI measurements and one or more of the plurality of cross-link interference measurements.

A method by a UE is described. The method may include receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs, performing one or more CSI measurements via the set of CMRs according to the first control signaling, performing a set of multiple CLI measurements via the set of IMRs, where the set of multiple IMRs corresponds to a set of multiple UEs, and transmitting a CSI report including one or more CSI metrics, a CSI metric based on the one or more CSI measurements and one or more of the set of multiple CLI measurements.

A UE is described. The UE may include one or more memories storing processor executable code, and one or more processors coupled with the one or more memories. The one or more processors may individually or collectively be operable to execute the code to cause the UE to receive first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs, perform one or more CSI measurements via the set of CMRs according to the first control signaling, perform a set of multiple CLI measurements via the set of IMRs, where the set of multiple IMRs corresponds to a set of multiple UEs, and transmit a CSI report including one or more CSI metrics, a CSI metric based on the one or more CSI measurements and one or more of the set of multiple CLI measurements.

Another UE is described. The UE may include means for receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs, means for performing one or more CSI measurements via the set of CMRs according to the first control signaling, means for performing a set of multiple CLI measurements via the set of IMRs, where the set of multiple IMRs corresponds to a set of multiple UEs, and means for transmitting a CSI report including one or more CSI metrics, a CSI metric based on the one or more CSI measurements and one or more of the set of multiple CLI measurements.

A non-transitory computer-readable medium storing code is described. The code may include instructions executable by one or more processors to receive first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs, perform one or more CSI measurements via the set of CMRs according to the first control signaling, perform a set of multiple CLI measurements via the set of IMRs, where the set of multiple IMRs corresponds to a set of multiple UEs, and transmit a CSI report including one or more CSI metrics, a CSI metric based on the one or more CSI measurements and one or more of the set of multiple CLI measurements.

Some examples of the method, UEs, and non-transitory computer-readable medium described herein may further include operations, features, means, or instructions for deriving the one or more CSI metrics based on a single CSI measurement of the one or more CSI measurements and one or more CLI measurements of the set of multiple CLI measurements, where the set of CMRs includes a single CMR.

Some examples of the method, UEs, and non-transitory computer-readable medium described herein may further include operations, features, means, or instructions for including, in an IMR index field in the first CSI report, an indication of an IMR index value indicating a first IMR of the set of multiple IMRs that corresponds to a first CLI measurement, of the set of multiple CLI measurements, from which the one or more CSI metrics may be derived, where the first CLI measurement corresponds to a smallest amount of measured CLI of the set of multiple CLI measurements.

Some examples of the method, UEs, and non-transitory computer-readable medium described herein may further include operations, features, means, or instructions for including, in a CSI reference signal (CSI-RS) resource indicator field of the first CSI report, an index value indicating a first IMR of the set of multiple IMRs that corresponds to a first CLI measurement, of the set of multiple CLI measurements, from which the one or more CSI metrics may be derived, where the first CLI measurement corresponds to a smallest amount of measured CLI of the set of multiple CLI measurements.

Some examples of the method, UEs, and non-transitory computer-readable medium described herein may further include operations, features, means, or instructions for including, in a set of multiple IMR index fields in the first CSI report, a set of IMR index values indicating a first subset of IMRs of the set of multiple IMRs that corresponds to a subset of CLI measurements, of the set of multiple CLI measurements, from which the one or more CSI metrics may be derived, where each of the subset of CLI measurements corresponds to smaller amounts of measured CLI than a remainder of CLI measurements of the set of multiple CLI measurements.

Some examples of the method, UEs, and non-transitory computer-readable medium described herein may further include operations, features, means, or instructions for transmitting the CSI report via a physical uplink shared channel (PUSCH) based on the one or more CSI metrics being based on the subset of CLI measurements, where the CSI report includes a second portion of a two-part CSI report.

Some examples of the method, UEs, and non-transitory computer-readable medium described herein may further include operations, features, means, or instructions for transmitting the CSI report via a physical uplink control channel (PUCCH) based on the one or more CSI metrics being based on a quantity of CLI measurements in the subset of CLI measurements satisfying a threshold, the CSI report including a wideband CSI report, a sub-band CSI report, or any combination thereof.

Some examples of the method, UEs, and non-transitory computer-readable medium described herein may further include operations, features, means, or instructions for deriving the one or more CSI metrics based on multiple CSI measurements of the one or more CSI measurements and one or more CLI measurements of the set of multiple CLI measurements, where the set of CMRs includes a set of multiple CMRs.

Some examples of the method, UEs, and non-transitory computer-readable medium described herein may further include operations, features, means, or instructions for including, in a CSI-RS resource indicator field of the first CSI report, an index value indicating a first CMR of the set of multiple CMRs and including, in an IMR index field in the first CSI report, an indication of an IMR index value indicating a first IMR of the set of multiple IMRs that corresponds to a first CLI measurement, of the set of multiple CLI measurements, from which the one or more CSI metrics may be derived, where the first CLI measurement corresponds to a smallest amount of measured CLI of the set of multiple CLI measurements.

Some examples of the method, UEs, and non-transitory computer-readable medium described herein may further include operations, features, means, or instructions for including, in a CSI-RS resource indicator field of the first CSI report, an index value indicating a first CMR of the set of multiple CMRs and including, in a set of multiple IMR index fields in the first CSI report, a set of IMR index values indicating a first subset of IMRs of the set of multiple IMRs that corresponds to a subset of CLI measurements, of the set of multiple CLI measurements, from which the one or more CSI metrics may be derived, where each of the subset of CLI measurements corresponds to smaller amounts of measured CLI than a remainder of CLI measurements of the set of multiple CLI measurements.

Some examples of the method, UEs, and non-transitory computer-readable medium described herein may further include operations, features, means, or instructions for transmitting the CSI report via a PUSCH based on a quantity of the set of multiple CLI measurements, where the CSI report includes a second portion of a two-part CSI report.

Some examples of the method, UEs, and non-transitory computer-readable medium described herein may further include operations, features, means, or instructions for transmitting the CSI report via a PUCCH based on the one or more CSI metrics being based on a quantity of transport blocks (TBs) corresponding to the CSI report satisfying a threshold.

Some examples of the method, UEs, and non-transitory computer-readable medium described herein may further include operations, features, means, or instructions for transmitting capability information indicating a computational capability for processing the CSI report, the computational capability based on a quantity of the set of CMRs, a second quantity of the set of IMRs, or both, where receiving the first control signaling may be based on the computational capability.

### BRIEF DESCRIPTION OF THE DRAWINGS

FIG. 1 shows an example of a wireless communications system that supports implicit cross-link interference reporting in sub-band full duplex in accordance with one or more aspects of the present disclosure.

FIG. 2 shows an example of a wireless communications system that supports implicit cross-link interference reporting in sub-band full duplex in accordance with one or more aspects of the present disclosure.

FIG. 3 shows an example of a CSI report configuration structure that supports implicit cross-link interference reporting in sub-band full duplex in accordance with one or more aspects of the present disclosure.

FIG. 4 shows an example of a process flow that supports implicit cross-link interference reporting in sub-band full duplex in accordance with one or more aspects of the present disclosure.

FIGS. 5 and 6 show block diagrams of devices that support implicit cross-link interference reporting in sub-band full duplex in accordance with one or more aspects of the present disclosure.

FIG. 7 shows a block diagram of a communications manager that supports implicit cross-link interference reporting in sub-band full duplex in accordance with one or more aspects of the present disclosure.

FIG. 8 shows a diagram of a system including a device that supports implicit cross-link interference reporting in sub-band full duplex in accordance with one or more aspects of the present disclosure.

FIGS. 9 through 11 show flowcharts illustrating methods that support implicit cross-link interference reporting in sub-band full duplex in accordance with one or more aspects of the present disclosure.

### DETAILED DESCRIPTION

In some wireless communications systems, a user equipment (UE) may be configured to communicate with a network entity in a full duplex mode. In some examples, network entity may communicate with multiple UEs in a full duplex mode. Uplink and downlink transmissions between the network entity and the multiple UEs (e.g., or between the UE and multiple network entities) may cause cross-link interference (CLI) at the UEs. For example, uplink transmission at a first UE may cause CLI at a second UE receiving a downlink transmission. The CLI may reduce communication efficiency and reliability at the interfering UEs.

According to techniques described herein, the UE may implicitly report information about CLI measurements in a channel state information (CSI) report. For example, the UE may receive control signaling indicating a set of channel measurement resources (CMRs) and a set of interference measurement resources (IMRs). The UE may perform one or more CIS measurements via the set of CMRs, and the UE may perform multiple CLI measurements via the set of IMRs. The UE may indicate one or more of the CLI resources with the least interference via the CSI report. Additionally, or alternatively, the UE may derive CSI metrics based on the CLI measurements. The UE may transmit the CSI report to the network entity. The network entity may schedule the multiple UEs based on the CSI reports such that UEs with high interference are not schedule for full duplex communication at the same time. The scheduling may provide for improved communications efficiency and reliability.

Aspects of the disclosure are initially described in the context of wireless communications systems. Additional aspects of the disclosure are described in the context of a CSI report configuration structure and process flow. Aspects of the disclosure are further illustrated by and described herein with reference to apparatus diagrams, system diagrams, and flowcharts that relate to implicit CLI reporting in sub-band full duplex.

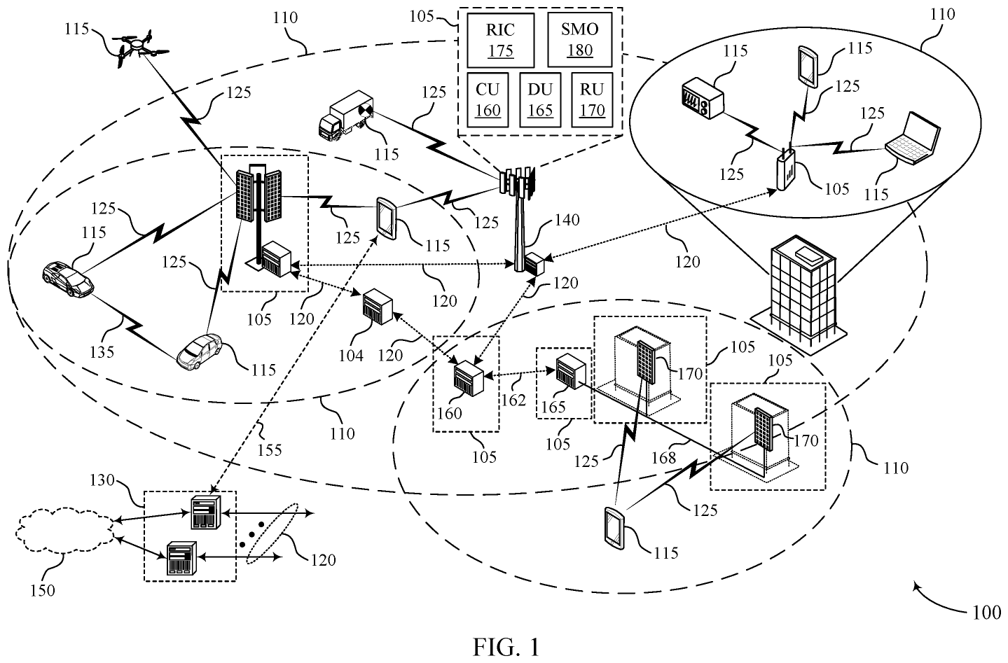

FIG. 1 shows an example of a wireless communications system 100 that supports implicit CLI reporting in sub-band full duplex in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, the UE 115 may transmit a CSI report to a network entity 105. The CSI report may be associated with a timing requirement. The timing requirements for CSI processing to may ensure (e.g., guarantee) that the UE 115 has enough time to generate CSI report. In some cases, the CSI report may be associated with an ultra-low latency timing requirement. The ultra-low latency may be based on some special cases (e.g., as defined in CSI computation delay requirement 1). In some cases, there may be multiple latency classes (e.g., as defined in CSI computation delay requirement 2). The multiple latency classes may include a low-latency class (e.g., Z1), a high-latency class (e.g., Z2), and a latency for beam-reporting (e.g., Z3). A quantity of symbols or an amount of latency (e.g., for CSI processing, beam delays) may depend on reported UE capability.

In some cases, the CSI report may be transmitted via a physical uplink shared channel (PUSCH) or a physical uplink control channel (PUCCH). The CSI report structure for CSI reports may include a first and second part (e.g., CSI part1 and CSI part2). For PUCCH The mapping order of CSI fields in the CSI report may be based on the CSI report being associated with a wideband or a sub-band. For PUSCH, the mapping order of the second part may be based on the CSI report being associated with a wideband or a sub-band. In some cases, the first part of the CSI report (e.g., CSI part 1) may include one or more CSI fields in a single report or as a first part of a two-part CSI report. The CSI fields (e.g., for a wideband CSI part 1) may be indicated by a format indicator for wideband PMI and wideband CQI, or as a report quantity, among other examples. Similarly, a mapping of an order of CSI part 2 for wideband or sub-band PMI may be configured. The first part of the CSI report or the second part of the CSI report may include different mappings or CSI fields based on the CSI report being transmitted on PUSCH or PUCCH. In some cases, different PUCCH formats may have different maximum payload sizes. For example, a UE 115 may not be expected to report CSI with a total quantity of uplink control information (UCI) bits and cyclic redundancy check (CRC) bits larger than a threshold (e.g., 115 bits) when configured with some PUCCH formats (e.g., PUCCH format 4).

According to techniques described herein, the UE 115 may implicitly include information about CLI measurements in a CSI report. For example, the UE 115 may receive control signaling indicating a set of CMRs and a set of IMRs. The UE 115 may perform one or more CIS measurements via the set of CMRs, and the UE 115 may perform multiple CLI measurements via the set of IMRs. The UE 115 may indicate one or more of the CLI resources with the least interference via the CSI report. Additionally, or alternatively, the UE 115 may derive CSI metrics based on the CLI measurements. The UE 115 may transmit the CSI report to the network entity. The network entity may schedule the multiple UEs 115 based on the CSI reports such that UEs 115 with high interference are not schedule for full duplex communication at the same time. The scheduling may provide for improved communications efficiency and reliability.

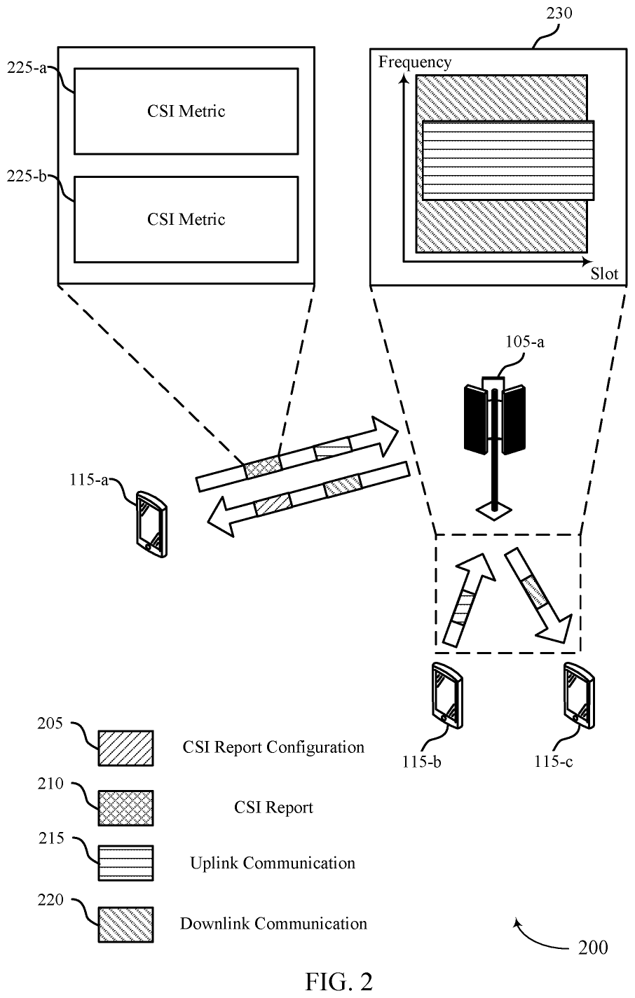

FIG. 2 shows an example of a wireless communications system 200 that supports implicit CLI reporting in sub-band full duplex in accordance with one or more aspects of the present disclosure. In some examples, wireless communications system 200 may implement aspects of wireless communications system 100. For example, a UE 115-a, a UE 115-b, and a UE 115-c may represent an example of a UE, such as the UEs 115 described herein with reference to FIG. 1. The network entity 105-a may represent an example of a network entity, such as the network entity 105 described herein with reference to FIG. 1. The UE 115-a may signal a CSI report 210 to the network entity 105-a. The CSI report 210 may include one or more CSI metrics 225 (e.g., a CSI metric 225-a and a CSI metric 225-b).

In some wireless communications systems, the UEs 115 (e.g., the UE 115-a, the UE 115-b, and the UE 115-c) may communicate with the network entity 105-a via full duplex communication. In some cases, the UEs 115 may communicate with the network entity 105-a via in-band full duplex (IBFD). The network entity 105-a or the UEs 115 may transmit and receive on the same time and frequency resource. That is, the downlink and uplink resources may share the same IBFD time or frequency resource (e.g., the downlink and uplink resources may fully or partially overlap). For example, the UE 115-b may transmit uplink communication 215 to the network entity 105-a and the network entity 105-a may transmit downlink communication 220 to the UE 115-c via the same time and frequency resource. In some cases, the uplink communication resources and the downlink communications resources may overlap in accordance with communication resources 230. That is, the uplink communication resources and the downlink communication resources may at least partially overlap (e.g., as illustrated in FIG. 2).

In some cases, the UEs 115 may communicate with the network entity 105-a via sub-band frequency division duplex (FDD) (e.g., flexible duplex or sub-band full duplex (SBFD). The network entity 105-a or the UEs 115 may transmit and receive at the same time but on the different frequency resource. For example, the downlink resources may be separated from uplink resources in frequency domain. In other words, the downlink resources may not overlap with the uplink resources in the frequency domain. In some examples, the downlink resources and the uplink resources within the same time resource may be separated by a guard band.

The full duplex operations may generate CLI between the UEs 115 or the network entity 105-a and another network entity 105. For example, the network entity 105-a may simultaneously transmit downlink communications 220 to the UE 115-c and receive uplink communications 215 from the UE 115-b in a full duplex mode. In some examples, the UE 115-a may simultaneously transmit uplink communication 215 to the network entity 105-a, and receive downlink signaling from the network entity 105-a or from another network entity 105 in a full duplex mode. In some examples, full duplex communications may result in interference (e.g., CLI). For example, the UE 115-b may transmit uplink communication 215, and the network entity 105-a may transmit downlink communication 220 to the UE 115-c. The transmitted uplink communication 215 may interfere with a downlink communication 220 at the UE 115-c. That is, the UE 115-b may generate CLI at the UE 115-c.

In some cases, the network entity 105-a may transmit a CSI report configuration 205 to the UE 115-a. The CSI report configuration may be associated with multiple measurement resources (e.g., CMRs or IMRs). For example, the CSI report configuration may include a non-zero power (NZP) CSI-RS resource configuration for channel measurement. The NZP CSI-RS resource configuration may include one or more NZP CMR sets. Each NZP CMR resource set may include multiple NZP CMR resources, or a single NZP CMR resource. The CSI report configuration 205 may include a zero power (ZP) CSI-RS resource configuration for interference measurement (e.g., CSI interference measurement (CSI-IM)). The CSI-IM resource configuration may include one or more CSI-IM resource sets. Each CSI-IM resource set may include multiple CSI-IM resources. The CSI-IM resources may be used by the UEs 115 to measure interference from other cells. Each NZP CMR resource may correspond to a CSI-IM resource (e.g., the NZP CMR resources may have one-to-one mapping to the CSI-IM resources). In some cases, the CSI report configuration 205 may include a NZP CSI-RS resource configuration for interference measurement. The NZP CSI-RS resource configuration may include one or more NZP IMR sets. Each NZP IMR resource set may include multiple IMR. The IMR may be used for detecting spatial domain multiplexing interference. That is, the IMR may be used by the UE 115-a to measure interference caused by a downlink transmission to another UE 115 (e.g., the UE 115-c). For example, if the network entity 105-a transmit downlink communication 220 to the UE 115-a and the UE 115-c, there may be some leakage (e.g., interference) between the transmissions. Each IMR may correspond to one or more CSI-IM resource (e.g., the CSI-IM may have a one-to-many mapping to the IMR). Each NZP CMR resource may be associated with every IMR.

In some cases, the CSI report configuration 205 may include a codebook configuration. The code book configuration may include the codebook type (e.g., type1-SinglePanel, type1-MultiPanel, or type2) and a rank indicator (RI) restriction.

In some cases, the CSI report configuration 205 may include report configuration type (e.g., periodic, semi-persistent, or aperiodic). In some cases, CSI report configurations 205 associated with periodic or semi-persistent configuration types may include one NZP CMR resource set, one CSI-IM resource set, or one NZP IMR set based on the configuration type. In some cases, CSI report triggering (e.g., configured by CSI report configurations 205) associated with aperiodic configuration types may select one set of the one or more NZP CMR resource sets, one set of the one or more CSI-IM resource sets, or one set of the one or more NZP IMR sets. In some cases, a single resource set within a resource setting may be used for measurement for a CSI report 210. In some examples, only a single resource set within a resource setting may be used for some CSI reports. In some examples, Periodic or semi-persistent CSI reports may be configured to include only one set of measurement resources (e.g., One CMR resource set). In some examples, for an aperiodic CSI report, an aperiodic CSI report trigger may select one resource set (e.g., one CMR resource set) to be used.

The UE 115-a may perform CLI reporting based on performing a set of CLI measurements via the set of IMRs. The UE 115-a may use a CSI framework as for CLI reporting and may use a separate measurement resource for CLI (e.g., IMRs). The UE 115-a may use layer one signaling to indicate information about the set of CLI measurements. The layer one signaling may capture the impact of inter-UE CLI. In some cases, the UE 115-a may perform implicit CLI reporting. CLI impact may be captured in reported CSI quantity or metrics (e.g., channel quality indicator (CQI) and layer one-signal to interference plus noise ratio (L1-SINR)). That is, the CSI metrics may be derived based on CSI measurements and based on the set of CLI measurements.

In some cases, the UE 115-a may perform explicit CLI reporting. For example, the UE 115-a may measure the CLI via an IMR, and the UE 115-a may report explicit CLI quantities (e.g., received signal strength indicator (RSSI) or reference signal received power (RSRP)) included in the report. The UE 115-a may report the CLI quantities via a new reportQuantity defined in the CSI report configuration 205. In some cases, the explicit CLI quantities may be included in a CLI report (e.g., reportQuantity=SRS-RSRP or CLI-RSSI). In some cases, the CLI quantities may be included in a CSI plus CLI report (e.g., reportQuantity=cri-CQI-RI-CLI_RSSI). The CSI report configuration 205 may include CLI metrics to one or more existing reportQunatities. The CSI report 210 including the CLI metrics may use a CSI report payload design.

For a scheduler at the network entity 105-a to minimize the impact of inter-UE CLI, proper UE-pairing may be used (e.g., may be relied on) for scheduling downlink or uplink in SBFD slots. That is, UEs 115 with low CLI can be scheduled simultaneously in an SBFD slot. For example, the UE 115-a and the UE 115-c may be schedule in the same SBFD slot based on a low CLI associated with the UEs 115. The UE 115-b and the UE 115-c may not be scheduled in the same SBFD slot based on a high CLI associated with the UEs 115.

To get accurate and timely CLI measurements, L1 measurement, and reporting may be used (e.g., relied upon). Additionality, the UE 115-a may perform CLI measurement in multiple resources to characterize CLI from different aggressor UEs 115 (e.g., UEs 115 generating CLI at the UE 115-a) or to characterize CLI in different spatial directions (e.g., quasi co-located spatial receive parameters (QCL-D) in frequency range two (FR2)).

According to techniques described herein, the UE 115-a may perform multiple CLI measurements (e.g., to capture CLI from multiple UEs or multiple QCL-D) for implicit CLI reporting where CSI metrics 225 (CQI or RI) are derived based on measured CLI. For example, the UE 115-a may be instructed by the CSI report configuration 205 to perform implicit CLI reporting via the CSI report 210. The UE 115-a may perform one or more channel measurements based on receiving a CSI-RS from the network entity 105-a. The UE 115-a may perform multiple CLI measurements. The CLI measurements may measure CLI from one or more UEs 115 (e.g., the UE 115-b and the UE 115-c). The UE 115-a may determine one or more CSI metrics 225 (e.g., the CSI metric 225-a and the CSI metric 225-b) based on the one or more channel measurements and the multiple CLI measurements. The UE 115-a may report the one or more CSI metrics 225 to the network entity 105-a via the CSI report 210. Implicit reporting of CLI (e.g., as captured via multiple CLI measurements) may be implicitly indicated via CSI reporting where reported CSI metrics are derived (e.g., for a given CRMs) based at least in part on the multiple CLI measurements.

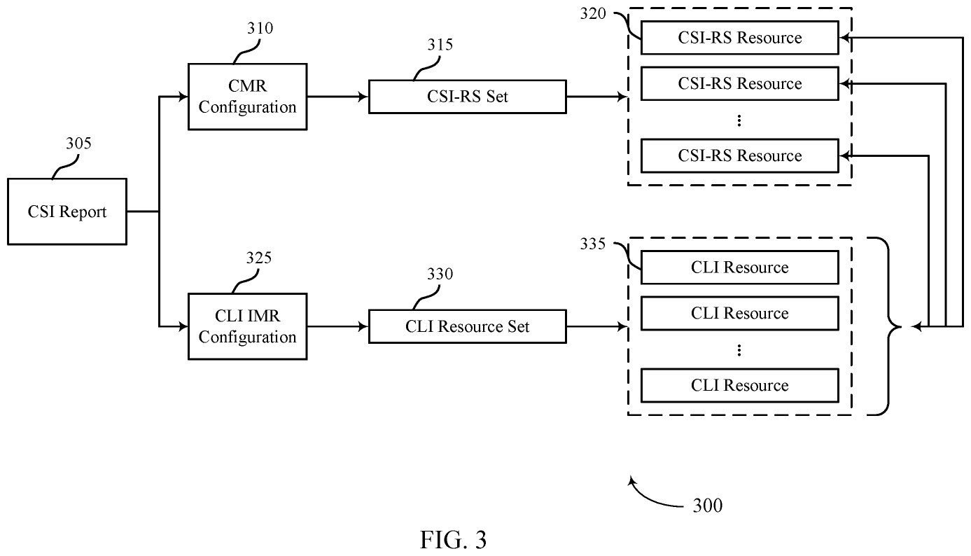

FIG. 3 shows an example of a CSI report configuration structure 300 that supports implicit CLI reporting in SBFD in accordance with one or more aspects of the present disclosure. In some examples, CSI report configuration structure 300 may implement aspects of, or be implemented by aspects of, the wireless communications system 100 or the wireless communications system 200. For example, the CSI report configuration structure 300 may be signaled by a UE 115 to a network entity 105 via a CSI report configuration, as described herein with reference to FIG. 2. The UE 115 and the network entity 105 may be examples of corresponding devices described herein with reference to FIGS. 1 and 2. In some cases, a network entity 105 may transmit a CSI report configuration 305 to a UE 115. The UE may transmit a CSI report to the network entity 105 in accordance with the CSI report configuration 305.

The CSI report configuration 305 may be configured to include a CMR configuration 310, as described herein with reference to FIG. 2. The CMR configuration 310 may include one or more CSI-RS sets 315. A CSI-RS set 315 may include multiple CSI-RS resources 320. According to techniques described herein, the CSI report configuration 305 may include CLI IMR configuration 325. The CLI IMR configuration may include CLI resource set 330. The CLI resource set 330 may include CLI resources (e.g., CLI resource 335). Each CSI-RS resource 320 may be mapped to every CLI resource (e.g., as illustrated in FIG. 3). That is, the CSI-RS resources 320 may have a one-to-many mapping to the CLI resources 335 (e.g., one CMR resource will be linked to M CLI measurement resources, where M is a quantity of the CLI resources 335).

For example, if the CLI resource set 330 includes M CLI resources 335 and the CSI-RS set 315 includes one CSI-RS resource 320, the UE 115 may perform one channel measurement (e.g., via the one CSI-RS resource 320) and M interference measurements (e.g., via the M CLI resources 335). The UE 115 may determine the CSI metrics based on the one channel measurement and update the CSI metrics based on the M interference measurements. In some cases, the UE 115 may report a subset of the CLI measurements. If the CSI-RS set 315 includes more than one CSI-RS resource 320, the UE 115 may update the CSI metrics associated with each CSI-RS resource based on the M interference measurements. By reporting the CSI metrics associated with the CSI-RS resource 320 and based on the CLI measurements, the UE 115-a may also implicitly report the CLI measurements.

In some cases, the CSI report may be linked to a single CSI-RS resource 320 (e.g., a single CMR CSI-RS resource) (e.g., which may be indicated in the control signaling that configures the CSI report). That is, the CSI-RS set 315 may include a single CSI-RS resource 320. For CSI reports linked with single NZP-CSI-RS for channel measurement (e.g., a single CSI-RS resource 320), the bit-width of CRI field in the CSI report may be zero (e.g., in a CSI report with reportQuantity=CRI-xxxx). The CRI field may be used to indicated which CSI-RS resource 320 of the CSI-RS set 315 corresponds to the CSI metrics reported in the CSI report. However, if the CSI-RS set 315 includes only a single CSI-RS resource 320, then the value in the bit-width of CRI field may be available to indicate a CLI resource 335 on which the CSI metrics are based.

The UE 115 may be configured with implicit CLI reporting (e.g., by configuration or implicitly based on linkage to CLI resource settings). The UE 115 may report an indication of a CLI resource 335 with least interference. That is, the UE 115-a may determine a CLI resource 335 with a least interference based on the CLI measurements (e.g., across all of the M CLI resources 335) and the UE 115-a may indicate the CLI resource 335 having the least interference (e.g., the best or lowest CLI measurement) in the CSI report. In some cases, the CSI metrics (e.g., CQI or RI) in the CSI reports may be derived based on the CLI measurement associated with the least interference.

In some cases, the CSI report may include a report quantity explicitly indicating an IMR index used in the CSI computations. The network entity 105 may request the IMR index via the CSI report configuration. For example, the CSI metrics may be based on a CLI measurement associated with an IMR corresponding to the IMR index (e.g., cri-RI-CQI→reportQuantity=cri-CLIri-RI-CQI, where CLIri takes value in {0, . . . , M−1} and M is the quantity of CLI resources 335 in the CLI resource set 330). The network entity 105 may determine the CLI resource 335 corresponding to the CSI metrics based on the IMR index.

In some cases, the CSI report may implicitly report the CLI measurements via another (e.g., repurposed) field in the CSI report. For example, the CSI report may reuse the CRI field (e.g., the CSI report may not define a new field) to indicate a CLI resource with a least amount of interference. The CRI field may be interpreted as a CLI resource index when the CSI report includes one CMR (e.g., one CSI-RS resource 320). The CRI field may be set to zero or may remain unused based on the CSI report including one CMR. The bit-width of the field may be equal to ceil (log2(M)), where M is the quantity of CLI resources 335 in the CLI resource set 330.

In some cases, the CSI report may be linked to multiple CMR resources (e.g., CSI-RS resources 320). That is, the CSI-RS set 315 may include multiple CSI-RS resources 320, and the CRI field may be used to indicate which of the CSI-RS resources 320 are used (e.g., have the best CSI metric values) for the CSI report. In some cases, the CSI report configuration 305 may define an additional field (e.g., an additional field in reportQuantity, reportQuantity=cri-CLIri-RI-CQI-PMI) to indicate a best CLI resource 335 (e.g., a CLI resource 335 associated with least interference). The CSI report may include an increased payload size (e.g., an additional payload size with additional ceil (log2(M)) bits). The indication of the best CLI resource 335 may indicate the CLI resource 335 based on which the CSI metrics (e.g., corresponding to the CSI-RS resource 320 indicated by the CRI field) are derived.

In some cases, the CSI report may be transmitted via a PUSCH. The additional field may be included in a second part of the CSI report (e.g., the additional field may be added to CSI-part2). For cri-CLIri-RI-CQI, the report may not be a single part based on CLIri being included in the second part of the CSI report (e.g., CSI-part2).

In some cases, the CSI report may be transmitted via PUCCH (e.g., CSI reporting including implicit CLI reporting may be supported via PUCCH if one or more conditions are satisfied or in one or more scenarios). In some examples, the UE 115 may transmit the CSI report via PUCCH in the case of semi-persistent CSI reporting via PUCCH format 2, 3, or 4. In some examples, the UE 115 may transmit the CSI report via PUCCH in the case of CSI reporting including a single transport block (TB) CSI (e.g., the CSI report may not be transmitted via PUCCH if the CSI report includes more than a threshold quantity of TBs). The CSI report may include the single TB instead of an additional TB including CQI fields (e.g., for wideband CQI). The second part of the CSI report (e.g., CSI-part2) may include the CLI fields (e.g., indicating which CLI resource 335 corresponds to the CSI-RS resource 320 reported in the CSI report). The cases in which PUCCH CSI reporting is supported may ensure that the CSI report may not exceed a threshold payload size on PUCCH.

In some cases, the UE 115 may report more than one CSI metrics considering a subset of CLI resources 335 (e.g., top L CSI corresponding to L CLI resources 335) with a least amount of interference. The UE 115 may report the subset of CLI resources 335 via a payload structure that supports reporting of multiple CLI resources 335. The payload structure may accommodate the L−1 additional CSI metrics. The payload may be based on the reporting structure on a PUSCH or PUCCH. For example, the payload structure may satisfy constraints on the payload size as PUCCH payload size is limited (e.g., PUCCH format 2 may support a limited payload size). PUSCH payload design may be more flexible compared to PUCCH (e.g., PUSCH may support larger payload sizes). Fields for PUSCH CSI reporting may be defined in CSI-part2. In some cases, the payload may be based on report structures for different reportQuantity.

In some cases, the UE 115 may transmit the CSI report associated with more than one CLI resources 335 (e.g., L>1) via PUSCH based on the large overhead compared to a CSI report associated with one CLI resource 335 (e.g., L=1). In other words, the payload structure may allow for reporting on PUSCH given the large overhead. The CSI report may be transmitted via the PUSCH (e.g., a CSI-part2 for CSI via PUSCH), where fields indicating the CLI resources 335 based on which the CSI metrics were derived may be included in the payload structure. For example, the UE 115 may report three CLI resources 335 (e.g., L=3). The UE 115 may report a first CLI resource 335 via a first part of the CSI report, and the UE 115-a may report a second and third CLI resource 335 via a second part of the CSI report (e.g., CSI-part2). The first CLI resource 335 may be report via a new field in the first part of the CSI report or via the CRI field.

In some cases, the UE 115 may transmit the CSI report associated with more than one CLI resources 335 (e.g., L>1) via PUCCH (e.g., PUCCH format 3 or 4) based on some conditions (e.g., Limit L<=X, where X is a threshold quantity of CLI resources 335 or wideband CSI reporting based on the already large overhead for sub band CSI). In other words, the payload structure may allow for reporting on PUCCH format 3 or 4 under some conditions. In some cases, the UE 115 may transmit the CSI report via PUSCH or PUCCH based on a quantity of CLI resources 335. For example, a threshold quantity of CLI resources 335 may be two. The UE 115 may transmit CSI reports with two or less CLI resources 335 via PUCCH, and the UE 115 may transmit CSI reports with more than two CLI resources 335 via PUSCH. In some examples, the CSI report may be transmitted via the PUCCH for wideband CSI reporting.

The UE 115 may support various processing times corresponding to the CSI report, processing capabilities for CSI reporting, or the like. For example, the UE 115 may determine a CSI processing unit (e.g., processing resources supporting CSI processing) threshold (e.g., requirement) at the UE 115, or timing threshold (e.g., a timing requirements expected by the network entity 105, based on Z or Z′ as described herein with reference to FIG. 1) based on the CSI reportQuantity and a quantity of CMRs associated with the CSI report. The multiple CLI resources 335 (e.g., CLI measurement resources) associated with the CSI report may introduce additional processing overhead at the UE 115. For example, each additional CMR or CLI resource 335 associated with the UE 115 may use additional processing time at the UE 115. In some examples, the network entity may not classify CSI reports with more than one CLI resource 335 (e.g., M>1) as ultra-low latency even if all other ultra-low latency conditions are satisfied (e.g., a single CSI with wideband frequency-granularity and to at most four CSI-RS ports in a single resource without a CRI report and where codebook Type is set to ‘type1-SinglePanel’ or where reportQuantity is set to ‘cri-RI-CQI’) based on the quantity of CLI resources 335 configured for the CSI report.

In some cases, the timing for processing and transmitting (e.g., Z1/Z1′, Z2/Z2′, Z3/Z3′) associated with the CSI report, as described herein with reference to FIG. 1, may be relied upon by one or more devices, but additional timing offsets or delays (e.g., relaxations) may be implemented for CSI reporting with implicit CLI in the case of multiple CLI measurements as described herein. In some cases, the timing thresholds may include a relaxation time (e.g., Zi_new=Zi_old+X, where X is a relaxation time, and a function of L). For example, the relaxation time may be based on the quantity of CLI resources 335 in the subset of CLI resources 335. For instance, a network entity may schedule a CSI report at a timing offset plus a relaxation time X, and the UE 115 may not be expected to transmit the CSI report until after the timing offset plus the relaxation time X. In some cases, for single-TRP (sTRP) CSI reports (e.g., sTRP reports) associated with K CMRs, the CPU occupancy may follow one or more rules for CPU occupancy (e.g., O_cpu=K). In some cases, for sTRP reports associated with K CMRs, the CPU occupancy may introduce some extra term (e.g., O_cpu=K+X, where X is a function of L). For example, the extra term may be based on the quantity of CLI resources 335 in the subset of CLI resources 335 (e.g., L). In such examples, the sTRP reporting may be defined or allocated according to a base or default calculation of CSI processing unites plus an extension function (e.g., X) defining the additional CSI processing unites utilized by the UE 115 for CSI reporting with implicit CLI reporting, as described herein.

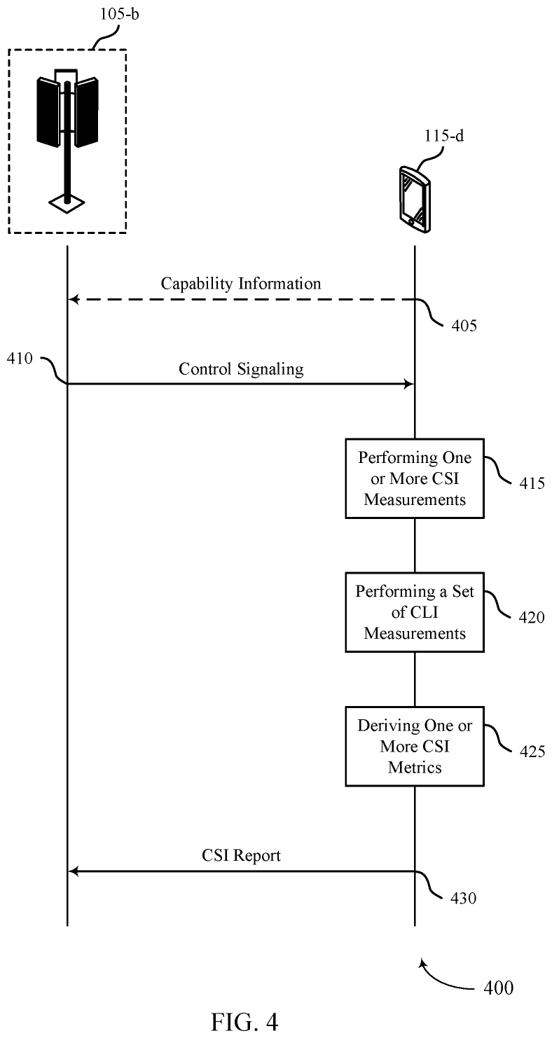

FIG. 4 shows an example of a process flow 400 that supports implicit CLI reporting in SBFD in accordance with one or more aspects of the present disclosure. In some examples, process flow 400 may implement aspects of, or be implemented by aspects of, the wireless communications system 100, wireless communications system 200, or the CSI report configuration structure 300. For example, the process flow 400 may include a UE 115-d and a network entity 105-b which may be examples of corresponding devices described herein with reference to FIGS. 1-3.

In some cases, at 405, the UE 115-d may transmit capability information indicating a computational capability for processing the CSI report, the computational capability based on a quantity of the set of CMRs, a second quantity of the set of IMRs, or both. Receiving first control signaling may be based on the computational capability.

At 410, the UE 115-d may receive the first control signaling indicating a set of CMRs including one or more CMRs and a set of IMRs including multiple IMRs. The set of CMRs and the set of IMRs corresponding to a first CSI report, and a CMR corresponding to the IMRs of the multiple IMRs.

At 415, the UE 115-d may perform one or more CSI measurements via the set of CMRs according to the first control signaling.

At 420, the UE 115-d may perform multiple of CLI measurements via the set of IMRs. The multiple of IMRs may correspond to multiple of UEs 115 (e.g., the UE 115-b and the UE 115-c as described herein with reference to FIG. 1).

In some cases, at 425, the UE 115-d may derive one or more CSI metrics based on a single CSI measurement of the one or more CSI measurements and one or more CLI measurements of the multiple of CLI measurements. The set of CMRs may include a single CMR.

In some cases, at 425, the UE 115-d may derive the one or more CSI metrics based on multiple CSI measurements of the one or more CSI measurements and one or more CLI measurements of the multiple of CLI measurements. The set of CMRs may include multiple CMRs.

At 430, the UE 115-d may transmit a CSI report including the one or more CSI metrics. A CSI metric may be based on the one or more CSI measurements and one or more of the plurality of CLI measurements.

In some cases, the UE 115-d may include, in an IMR index field in the first CSI report, an indication of an IMR index value indicating a first IMR of the multiple of IMRs that corresponds to a first CLI measurement, of the multiple of CLI measurements, from which the one or more CSI metrics are derived. The first CLI measurement may correspond to a smallest amount of measured CLI of the multiple of CLI measurements.

In some cases, the UE 115-d may include, in a CSI-RS resource indicator field of the first CSI report, an index value indicating a first IMR of the multiple IMRs that corresponds to a first CLI measurement, of the plurality of CLI measurements, from which the one or more CSI metrics are derived. The first CLI measurement may correspond to a smallest amount of measured CLI of the plurality of CLI measurements.

In some cases, the UE 115-d may include, in a set of IMR index fields in the first CSI report, a set of IMR index values indicating a first subset of IMRs of the multiple IMRs that corresponds to a subset of CLI measurements, of the multiple CLI measurements, from which the one or more CSI metrics are derived. Each of the subset of CLI measurements may correspond to smaller amounts of measured CLI than a remainder of CLI measurements of the plurality of CLI measurements.

In some cases, the UE 115-d may transmit the CSI report via a PUSCH based on the one or more CSI metrics being based on the subset of CLI measurements. The CSI report may include a second portion of a two-part CSI report.

In some cases, the UE 115-d may transmit the CSI report via a PUCCH based on the one or more CSI metrics being based on a quantity of CLI measurements in the subset of CLI measurements satisfying a threshold. The CSI report may include a wideband CSI report, a sub-band CSI report, or both.

In some cases, the UE 115-d may include, in a CSI-RS resource indicator field of the first CSI report, an index value indicating a first CMR of the multiple CMRs. The UE 115-d may include, in an IMR index field in the first CSI report, an indication of an IMR index value indicating a first IMR of the multiple IMRs that corresponds to a first CLI measurement, of the plurality of CLI measurements, from which the one or more CSI metrics are derived. The first CLI measurement may correspond to a smallest amount of measured CLI of the multiple CLI measurements.

In some cases, the UE 115-d may including, in a CSI-RS resource indicator field of the first CSI report, an index value indicating a first CMR of the plurality of CMRs. The UE 115-d may include, in multiple of IMR index fields in the first CSI report, a set of IMR index values indicating a first subset of IMRs of the plurality of IMRs that corresponds to a subset of CLI measurements, of the plurality of CLI measurements, from which the one or more CSI metrics are derived. Each of the subset of CLI measurements may correspond to smaller amounts of measured CLI than a remainder of CLI measurements of the multiple CLI measurements.

In some cases, the UE 115-d may transmit the CSI report via a PUSCH based on a quantity of the multiple CLI measurements. The CSI report may include a second portion of a two-part CSI report.

In some cases, the UE 115-d may transmit the CSI report via a PUCCH based on the one or more CSI metrics being based on a quantity of TBs corresponding to the CSI report satisfying a threshold.

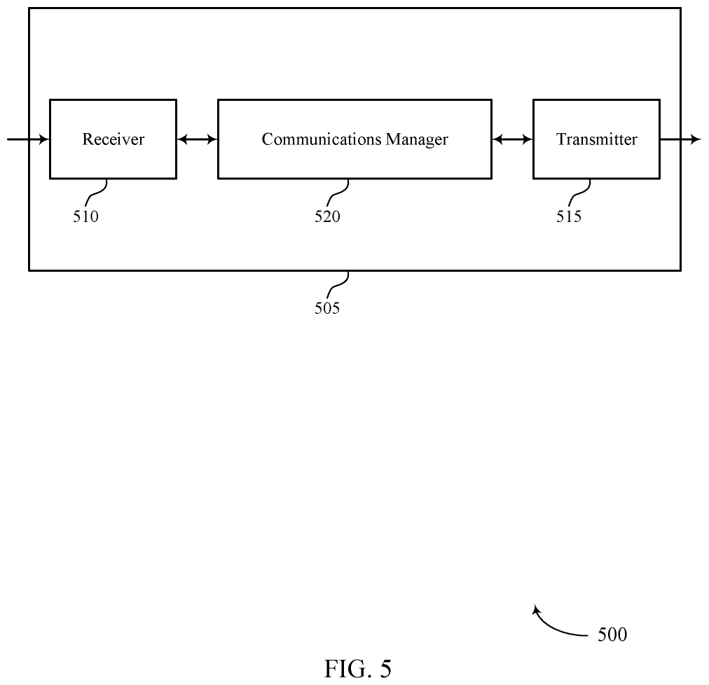

FIG. 5 shows a block diagram 500 of a device 505 that supports implicit CLI reporting in SBFD in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor (not shown), which may be coupled with at least one memory (not shown), to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to implicit CLI reporting in SBFD). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to implicit CLI reporting in SBFD). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of implicit CLI reporting in SBFD as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The communications manager 520 is capable of, configured to, or operable to support a means for performing one or more CSI measurements via the set of CMRs according to the first control signaling. The communications manager 520 is capable of, configured to, or operable to support a means for performing a set of multiple CLI measurements via the set of IMRs, where the set of multiple IMRs corresponds to a set of multiple UEs. The communications manager 520 is capable of, configured to, or operable to support a means for transmitting a CSI report including one or more CSI metrics, a CSI metric based on the one or more CSI measurements and one or more of the set of multiple CLI measurements.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and the like.

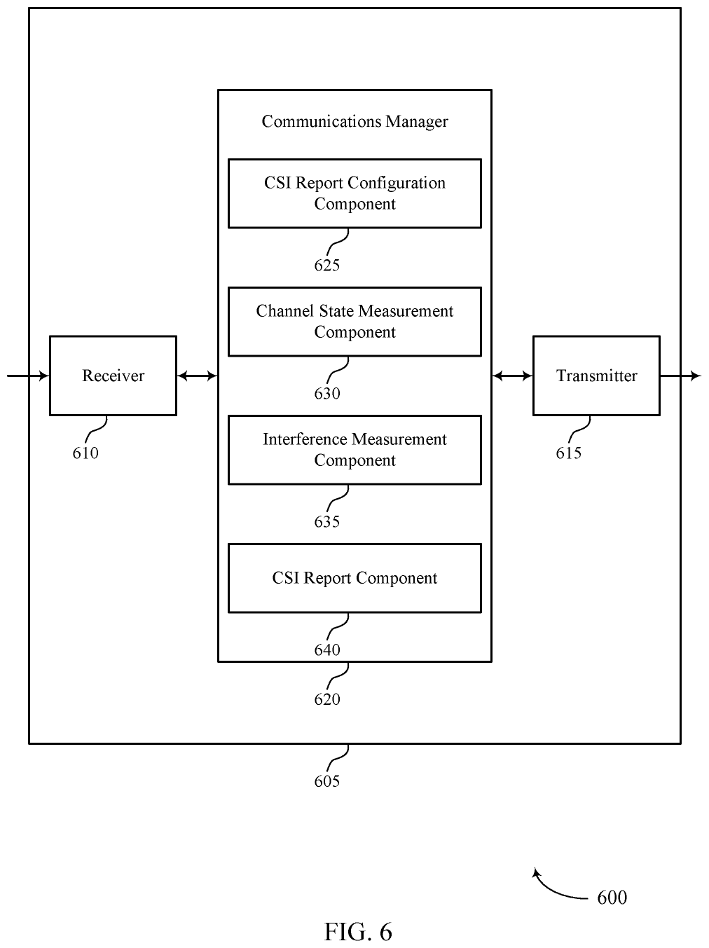

FIG. 6 shows a block diagram 600 of a device 605 that supports implicit CLI reporting in SBFD in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor (not shown), which may be coupled with at least one memory (not shown), to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to implicit CLI reporting in SBFD). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to implicit CLI reporting in SBFD). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of implicit CLI reporting in SBFD as described herein. For example, the communications manager 620 may include a CSI Report Configuration Component 625, a Channel State Measurement Component 630, an Interference Measurement Component 635, a CSI Report Component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The CSI Report Configuration Component 625 is capable of, configured to, or operable to support a means for receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The Channel State Measurement Component 630 is capable of, configured to, or operable to support a means for performing one or more CSI measurements via the set of CMRs according to the first control signaling. The Interference Measurement Component 635 is capable of, configured to, or operable to support a means for performing a set of multiple CLI measurements via the set of IMRs, where the set of multiple IMRs corresponds to a set of multiple UEs. The CSI Report Component 640 is capable of, configured to, or operable to support a means for transmitting a CSI report including one or more CSI metrics, a CSI metric based on the one or more CSI measurements and one or more of the set of multiple CLI measurements.

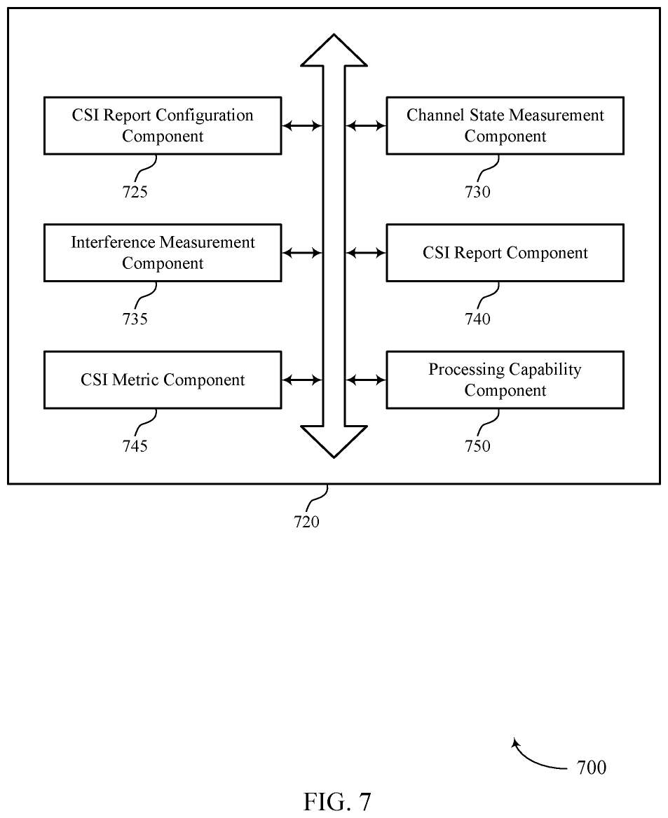

FIG. 7 shows a block diagram 700 of a communications manager 720 that supports implicit CLI reporting in SBFD in accordance with one or more aspects of the present disclosure. The communications manager 720 may be an example of aspects of a communications manager 520, a communications manager 620, or both, as described herein. The communications manager 720, or various components thereof, may be an example of means for performing various aspects of implicit CLI reporting in SBFD as described herein. For example, the communications manager 720 may include a CSI Report Configuration Component 725, a Channel State Measurement Component 730, an Interference Measurement Component 735, a CSI Report Component 740, a CSI Metric Component 745, a Processing Capability Component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The CSI Report Configuration Component 725 is capable of, configured to, or operable to support a means for receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The Channel State Measurement Component 730 is capable of, configured to, or operable to support a means for performing one or more CSI measurements via the set of CMRs according to the first control signaling. The Interference Measurement Component 735 is capable of, configured to, or operable to support a means for performing a set of multiple CLI measurements via the set of IMRs, where the set of multiple IMRs corresponds to a set of multiple UEs. The CSI Report Component 740 is capable of, configured to, or operable to support a means for transmitting a CSI report including one or more CSI metrics, a CSI metric based on the one or more CSI measurements and one or more of the set of multiple CLI measurements.

In some examples, the CSI Metric Component 745 is capable of, configured to, or operable to support a means for deriving the one or more CSI metrics based on a single CSI measurement of the one or more CSI measurements and one or more CLI measurements of the set of multiple CLI measurements, where the set of CMRs includes a single CMR.

In some examples, the CSI Report Component 740 is capable of, configured to, or operable to support a means for including, in an IMR index field in the first CSI report, an indication of an IMR index value indicating a first IMR of the set of multiple IMRs that corresponds to a first CLI measurement, of the set of multiple CLI measurements, from which the one or more CSI metrics are derived, where the first CLI measurement corresponds to a smallest amount of measured CLI of the set of multiple CLI measurements.

In some examples, the CSI Report Component 740 is capable of, configured to, or operable to support a means for including, in a CSI-RS resource indicator field of the first CSI report, an index value indicating a first IMR of the set of multiple IMRs that corresponds to a first CLI measurement, of the set of multiple CLI measurements, from which the one or more CSI metrics are derived, where the first CLI measurement corresponds to a smallest amount of measured CLI of the set of multiple CLI measurements.

In some examples, the CSI Report Component 740 is capable of, configured to, or operable to support a means for including, in a set of multiple IMR index fields in the first CSI report, a set of IMR index values indicating a first subset of IMRs of the set of multiple IMRs that corresponds to a subset of CLI measurements, of the set of multiple CLI measurements, from which the one or more CSI metrics are derived, where each of the subset of CLI measurements corresponds to smaller amounts of measured CLI than a remainder of CLI measurements of the set of multiple CLI measurements.

In some examples, the CSI Report Component 740 is capable of, configured to, or operable to support a means for transmitting the CSI report via a PUSCH based on the one or more CSI metrics being based on the subset of CLI measurements, where the CSI report includes a second portion of a two-part CSI report.

In some examples, the CSI Report Component 740 is capable of, configured to, or operable to support a means for transmitting the CSI report via a PUCCH based on the one or more CSI metrics being based on a quantity of CLI measurements in the subset of CLI measurements satisfying a threshold, the CSI report including a wideband CSI report, a sub-band CSI report, or both.

In some examples, the CSI Metric Component 745 is capable of, configured to, or operable to support a means for deriving the one or more CSI metrics based on multiple CSI measurements of the one or more CSI measurements and one or more CLI measurements of the set of multiple CLI measurements, where the set of CMRs includes a set of multiple CMRs.

In some examples, the CSI Report Component 740 is capable of, configured to, or operable to support a means for including, in a CSI-RS resource indicator field of the first CSI report, an index value indicating a first CMR of the set of multiple CMRs. In some examples, the CSI Report Component 740 is capable of, configured to, or operable to support a means for including, in an IMR index field in the first CSI report, an indication of an IMR index value indicating a first IMR of the set of multiple IMRs that corresponds to a first CLI measurement, of the set of multiple CLI measurements, from which the one or more CSI metrics are derived, where the first CLI measurement corresponds to a smallest amount of measured CLI of the set of multiple CLI measurements.

In some examples, the CSI Report Component 740 is capable of, configured to, or operable to support a means for including, in a CSI-RS resource indicator field of the first CSI report, an index value indicating a first CMR of the set of multiple CMRs. In some examples, the CSI Report Component 740 is capable of, configured to, or operable to support a means for including, in a set of multiple IMR index fields in the first CSI report, a set of IMR index values indicating a first subset of IMRs of the set of multiple IMRs that corresponds to a subset of CLI measurements, of the set of multiple CLI measurements, from which the one or more CSI metrics are derived, where each of the subset of CLI measurements corresponds to smaller amounts of measured CLI than a remainder of CLI measurements of the set of multiple CLI measurements.

In some examples, the CSI Report Component 740 is capable of, configured to, or operable to support a means for transmitting the CSI report via a PUSCH based on a quantity of the set of multiple CLI measurements, where the CSI report includes a second portion of a two-part CSI report.

In some examples, the CSI Report Component 740 is capable of, configured to, or operable to support a means for transmitting the CSI report via a PUCCH based on the one or more CSI metrics being based on a quantity of TBs corresponding to the CSI report satisfying a threshold.

In some examples, the Processing Capability Component 750 is capable of, configured to, or operable to support a means for transmitting capability information indicating a computational capability for processing the CSI report, the computational capability based on a quantity of the set of CMRs, a second quantity of the set of IMRs, or both, where receiving the first control signaling is based on the computational capability.

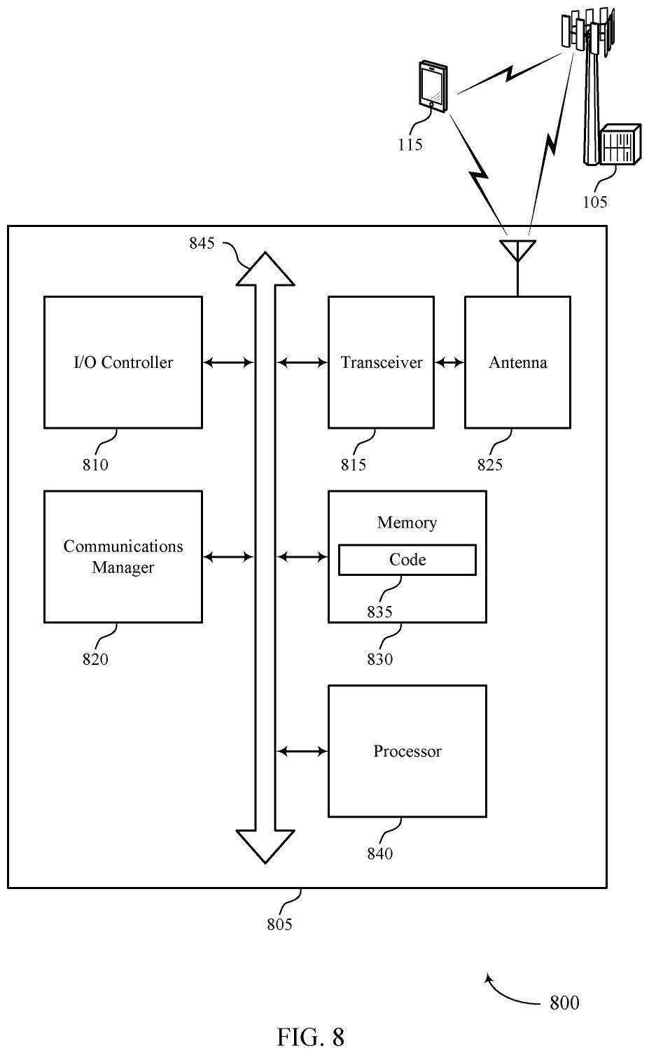

FIG. 8 shows a diagram of a system 800 including a device 805 that supports implicit CLI reporting in SBFD in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting implicit CLI reporting in SBFD). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The communications manager 820 is capable of, configured to, or operable to support a means for performing one or more CSI measurements via the set of CMRs according to the first control signaling. The communications manager 820 is capable of, configured to, or operable to support a means for performing a set of multiple CLI measurements via the set of IMRs, where the set of multiple IMRs corresponds to a set of multiple UEs. The communications manager 820 is capable of, configured to, or operable to support a means for transmitting a CSI report including one or more CSI metrics, a CSI metric based on the one or more CSI measurements and one or more of the set of multiple CLI measurements.

By including or configuring the communications manager 820 in accordance with examples as described herein, the device 805 may support techniques for improved communication reliability, reduced latency, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described herein with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of implicit CLI reporting in SBFD as described herein, or the at least one processor 840 and the at least one memory 830 may be otherwise configured to, individually or collectively, perform or support such operations.

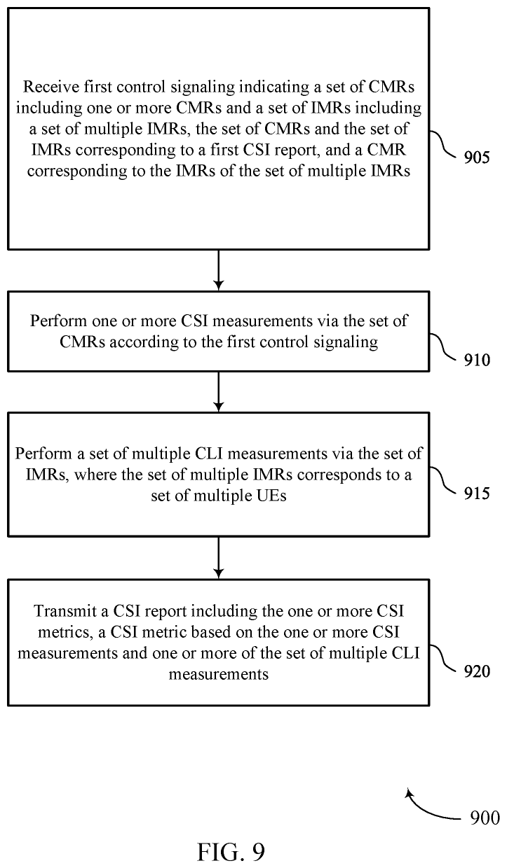

FIG. 9 shows a flowchart illustrating a method 900 that supports implicit CLI reporting in SBFD in accordance with one or more aspects of the present disclosure. The operations of the method 900 may be implemented by a UE or its components as described herein. For example, the operations of the method 900 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The operations of 905 may be performed in accordance with examples as disclosed herein. In some examples, aspects of the operations of 905 may be performed by a CSI Report Configuration Component 725 as described herein with reference to FIG. 7.

At 910, the method may include performing one or more CSI measurements via the set of CMRs according to the first control signaling. The operations of 910 may be performed in accordance with examples as disclosed herein. In some examples, aspects of the operations of 910 may be performed by a Channel State Measurement Component 730 as described herein with reference to FIG. 7.

At 915, the method may include performing a set of multiple CLI measurements via the set of IMRs, where the set of multiple IMRs corresponds to a set of multiple UEs. The operations of 915 may be performed in accordance with examples as disclosed herein. In some examples, aspects of the operations of 915 may be performed by an Interference Measurement Component 735 as described herein with reference to FIG. 7.

At 920, the method may include transmitting a CSI report including one or more CSI metrics, a CSI metric based on the one or more CSI measurements and one or more of the set of multiple CLI measurements. The operations of 920 may be performed in accordance with examples as disclosed herein. In some examples, aspects of the operations of 920 may be performed by a CSI Report Component 740 as described herein with reference to FIG. 7.

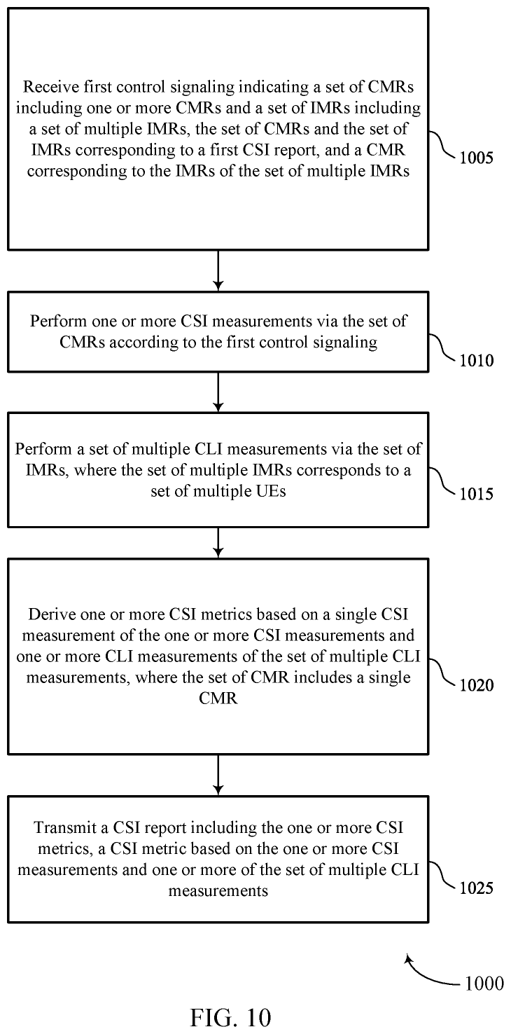

FIG. 10 shows a flowchart illustrating a method 1000 that supports implicit CLI reporting in SBFD in accordance with one or more aspects of the present disclosure. The operations of the method 1000 may be implemented by a UE or its components as described herein. For example, the operations of the method 1000 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The operations of 1005 may be performed in accordance with examples as disclosed herein. In some examples, aspects of the operations of 1005 may be performed by a CSI Report Configuration Component 725 as described herein with reference to FIG. 7.

At 1010, the method may include performing one or more CSI measurements via the set of CMRs according to the first control signaling. The operations of 1010 may be performed in accordance with examples as disclosed herein. In some examples, aspects of the operations of 1010 may be performed by a Channel State Measurement Component 730 as described herein with reference to FIG. 7.

At 1015, the method may include performing a set of multiple CLI measurements via the set of IMRs, where the set of multiple IMRs corresponds to a set of multiple UEs. The operations of 1015 may be performed in accordance with examples as disclosed herein. In some examples, aspects of the operations of 1015 may be performed by an Interference Measurement Component 735 as described herein with reference to FIG. 7.

At 1020, the method may include deriving one or more CSI metrics based on a single CSI measurement of the one or more CSI measurements and one or more CLI measurements of the set of multiple CLI measurements, where the set of CMRs includes a single CMR. The operations of 1020 may be performed in accordance with examples as disclosed herein. In some examples, aspects of the operations of 1020 may be performed by a CSI Metric Component 745 as described herein with reference to FIG. 7.

At 1025, the method may include transmitting a CSI report including the one or more CSI metrics, a CSI metric based on the one or more CSI measurements and one or more of the set of multiple CLI measurements. The operations of 1025 may be performed in accordance with examples as disclosed herein. In some examples, aspects of the operations of 1025 may be performed by a CSI Report Component 740 as described herein with reference to FIG. 7.

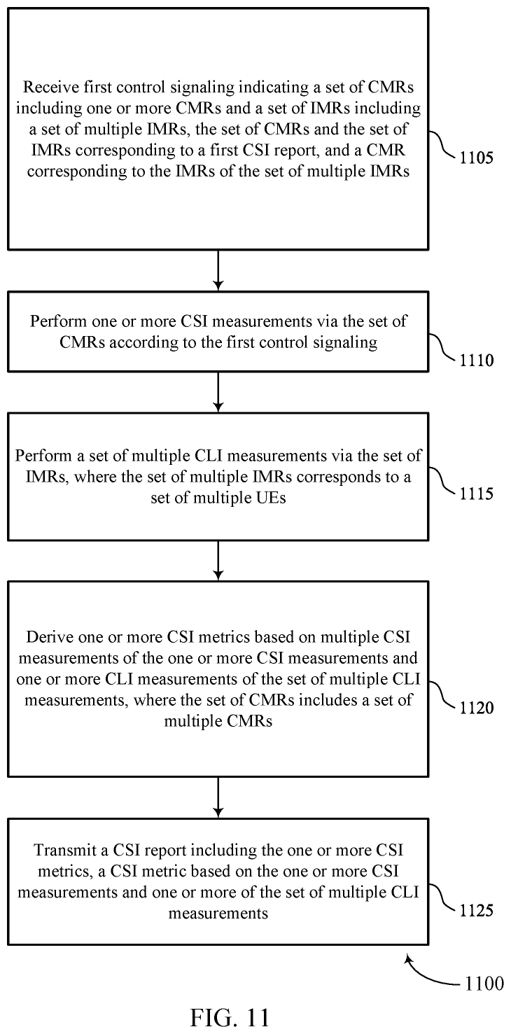

FIG. 11 shows a flowchart illustrating a method 1100 that supports implicit CLI reporting in SBFD in accordance with one or more aspects of the present disclosure. The operations of the method 1100 may be implemented by a UE or its components as described herein. For example, the operations of the method 1100 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling indicating a set of CMRs including one or more CMRs and a set of IMRs including a set of multiple IMRs, the set of CMRs and the set of IMRs corresponding to a first CSI report, and a CMR corresponding to the IMRs of the set of multiple IMRs. The operations of 1105 may be performed in accordance with examples as disclosed herein. In some examples, aspects of the operations of 1105 may be performed by a CSI Report Configuration Component 725 as described herein with reference to FIG. 7.

At 1110, the method may include performing one or more CSI measurements via the set of CMRs according to the first control signaling. The operations of 1110 may be performed in accordance with examples as disclosed herein. In some examples, aspects of the operations of 1110 may be performed by a Channel State Measurement Component 730 as described herein with reference to FIG. 7.

At 1115, the method may include performing a set of multiple CLI measurements via the set of IMRs, where the set of multiple IMRs corresponds to a set of multiple UEs. The operations of 1115 may be performed in accordance with examples as disclosed herein. In some examples, aspects of the operations of 1115 may be performed by an Interference Measurement Component 735 as described herein with reference to FIG. 7.

At 1120, the method may include deriving one or more CSI metrics based on multiple CSI measurements of the one or more CSI measurements and one or more CLI measurements of the set of multiple CLI measurements, where the set of CMRs includes a set of multiple CMRs. The operations of 1120 may be performed in accordance with examples as disclosed herein. In some examples, aspects of the operations of 1120 may be performed by a CSI Metric Component 745 as described herein with reference to FIG. 7.

At 1125, the method may include transmitting a CSI report including the one or more CSI metrics, a CSI metric based on the one or more CSI measurements and one or more of the set of multiple CLI measurements. The operations of 1125 may be performed in accordance with examples as disclosed herein. In some examples, aspects of the operations of 1125 may be performed by a CSI Report Component 740 as described herein with reference to FIG. 7.

The following provides an overview of aspects of the present disclosure:

Aspect 1: A method by a UE, comprising: receiving first control signaling indicating a set of CMRs comprising one or more CMRs and a set of IMRs comprising a plurality of IMRs, the set of CMRs and the set of IMRs corresponding to a first CSI report, and a CMR corresponding to the IMRs of the plurality of IMRs; performing one or more CSI measurements via the set of CMRs according to the first control signaling; performing a plurality of CLI measurements via the set of IMRs, wherein the plurality of IMRs corresponds to a plurality of UEs; and transmitting a CSI report comprising one or more CSI metrics, a CSI metric based at least in part on the one or more CSI measurements and one or more of the plurality of CLI measurements.

Aspect 2: The method of aspect 1, further comprising: deriving the one or more CSI metrics based at least in part on a single CSI measurement of the one or more CSI measurements and one or more CLI measurements of the plurality of CLI measurements, wherein the set of CMRs comprises a single CMR.

Aspect 3: The method of aspect 2, further comprising: including, in an IMR index field in the first CSI report, an indication of an IMR index value indicating a first IMR of the plurality of IMRs that corresponds to a first CLI measurement, of the plurality of CLI measurements, from which the one or more CSI metrics are derived, wherein the first CLI measurement corresponds to a smallest amount of measured CLI of the plurality of CLI measurements.

Aspect 4: The method of aspect 2, further comprising: including, in a CSI-RS resource indicator field of the first CSI report, an index value indicating a first IMR of the plurality of IMRs that corresponds to a first CLI measurement, of the plurality of CLI measurements, from which the one or more CSI metrics are derived, wherein the first CLI measurement corresponds to a smallest amount of measured CLI of the plurality of CLI measurements.

Aspect 5: The method of aspect 2, further comprising: including, in a plurality of IMR index fields in the first CSI report, a set of IMR index values indicating a first subset of IMRs of the plurality of IMRs that corresponds to a subset of CLI measurements, of the plurality of CLI measurements, from which the one or more CSI metrics are derived, wherein each of the subset of CLI measurements corresponds to smaller amounts of measured CLI than a remainder of CLI measurements of the plurality of CLI measurements.

Aspect 6: The method of aspect 5, further comprising: transmitting the CSI report via a PUSCH based at least in part on the one or more CSI metrics being based at least in part on the subset of CLI measurements, wherein the CSI report comprises a second portion of a two-part CSI report.

Aspect 7: The method of any of aspects 5, further comprising: transmitting the CSI report via a PUCCH based at least in part on the one or more CSI metrics being based at least in part on a quantity of CLI measurements in the subset of CLI measurements satisfying a threshold, the CSI report comprising a wideband CSI report, a sub-band CSI report, or any combination thereof.

Aspect 8: The method of aspect 1, further comprising: deriving the one or more CSI metrics based at least in part on multiple CSI measurements of the one or more CSI measurements and one or more CLI measurements of the plurality of CLI measurements, wherein the set of CMRs comprises a plurality of CMRs.

Aspect 9: The method of aspect 8, further comprising: including, in a CSI-RS resource indicator field of the first CSI report, an index value indicating a first CMR of the plurality of CMRs; and including, in an IMR index field in the first CSI report, an indication of an IMR index value indicating a first IMR of the plurality of IMRs that corresponds to a first CLI measurement, of the plurality of CLI measurements, from which the one or more CSI metrics are derived, wherein the first CLI measurement corresponds to a smallest amount of measured CLI of the plurality of CLI measurements.

Aspect 10: The method of aspect 8, further comprising: including, in a CSI-RS resource indicator field of the first CSI report, an index value indicating a first CMR of the plurality of CMRs; and including, in a plurality of IMR index fields in the first CSI report, a set of IMR index values indicating a first subset of IMRs of the plurality of IMRs that corresponds to a subset of CLI measurements, of the plurality of CLI measurements, from which the one or more CSI metrics are derived, wherein each of the subset of CLI measurements corresponds to smaller amounts of measured CLI than a remainder of CLI measurements of the plurality of CLI measurements.

Aspect 11: The method of any of aspects 8 through 10, further comprising: transmitting the CSI report via a PUSCH based at least in part on a quantity of the plurality of CLI measurements, wherein the CSI report comprises a second portion of a two-part CSI report.

Aspect 12: The method of any of aspects 8 through 10, further comprising: transmitting the CSI report via a PUCCH based at least in part on the one or more CSI metrics being based at least in part on a quantity of TBs corresponding to the CSI report satisfying a threshold.

Aspect 13: The method of any of aspects 1 through 12, further comprising: transmitting capability information indicating a computational capability for processing the CSI report, the computational capability based at least in part on a quantity of the set of CMRs, a second quantity of the set of IMRs, or both, wherein receiving the first control signaling is based at least in part on the computational capability.

Aspect 14: A UE comprising one or more memories storing processor-executable code, and one or more processors coupled with the one or more memories and individually or collectively operable to execute the code to cause the UE to perform a method of any of aspects 1 through 13.

Aspect 15: A UE comprising at least one means for performing a method of any of aspects 1 through 13.

Aspect 16: A non-transitory computer-readable medium storing code the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a set of channel measurement resources comprising one or more channel measurement resources and a set of interference measurement resources comprising a plurality of interference measurement resources, the set of channel measurement resources and the set of interference measurement resources corresponding to a first channel state information report, and a channel measurement resource corresponding to the interference measurement resources of the plurality of interference measurement resources;
perform one or more channel state information measurements via the set of channel measurement resources according to the first control signaling;
perform a plurality of cross-link interference measurements via the set of interference measurement resources, wherein the plurality of interference measurement resources corresponds to a plurality of UEs; and
transmit a channel state information report comprising one or more channel state information metrics, a channel state information metric based at least in part on the one or more channel state information measurements and one or more of the plurality of cross-link interference measurements.

2. The UE of claim 1, wherein the one or more processors are individually or collectively further operable to execute the code to cause the UE to:
derive the one or more channel state information metrics based at least in part on a single channel state information measurement of the one or more channel state information measurements and one or more cross-link interference measurements of the plurality of cross-link interference measurements, wherein the set of channel measurement resources comprises a single channel measurement resource.

3. The UE of claim 2, wherein the one or more processors are individually or collectively further operable to execute the code to cause the UE to:
include, in an interference measurement resource index field in the first channel state information report, an indication of an interference measurement resource index value indicating a first interference measurement resource of the plurality of interference measurement resources that corresponds to a first cross-link interference measurement, of the plurality of cross-link interference measurements, from which the one or more channel state information metrics are derived, wherein the first cross-link interference measurement corresponds to a smallest amount of measured cross-link interference of the plurality of cross-link interference measurements.

4. The UE of claim 2, wherein the one or more processors are individually or collectively further operable to execute the code to cause the UE to:
include, in a channel state information reference signal resource indicator field of the first channel state information report, an index value indicating a first interference measurement resource of the plurality of interference measurement resources that corresponds to a first cross-link interference measurement, of the plurality of cross-link interference measurements, from which the one or more channel state information metrics are derived, wherein the first cross-link interference measurement corresponds to a smallest amount of measured cross-link interference of the plurality of cross-link interference measurements.

5. The UE of claim 2, wherein the one or more processors are individually or collectively further operable to execute the code to cause the UE to:
include, in a plurality of interference measurement resource index fields in the first channel state information report, a set of interference measurement resource index values indicating a first subset of interference measurement resources of the plurality of interference measurement resources that corresponds to a subset of cross-link interference measurements, of the plurality of cross-link interference measurements, from which the one or more channel state information metrics are derived, wherein each of the subset of cross-link interference measurements corresponds to smaller amounts of measured cross-link interference than a remainder of cross-link interference measurements of the plurality of cross-link interference measurements.

6. The UE of claim 5, wherein the one or more processors are individually or collectively further operable to execute the code to cause the UE to:
transmit the channel state information report via a physical uplink shared channel based at least in part on the one or more channel state information metrics being based at least in part on the subset of cross-link interference measurements, wherein the channel state information report comprises a second portion of a two-part channel state information report.

7. The UE of claim 5, wherein the one or more processors are individually or collectively further operable to execute the code to cause the UE to:
transmit the channel state information report via a physical uplink control channel based at least in part on the one or more channel state information metrics being based at least in part on a quantity of cross-link interference measurements in the subset of cross-link interference measurements satisfying a threshold, the channel state information report comprising a wideband channel state information report, a sub-band channel state information report, or any combination thereof.

8. The UE of claim 1, wherein the one or more processors are individually or collectively further operable to execute the code to cause the UE to:
derive the one or more channel state information metrics based at least in part on multiple channel state information measurements of the one or more channel state information measurements and one or more cross-link interference measurements of the plurality of cross-link interference measurements, wherein the set of channel measurement resources comprises a plurality of channel measurement resources.

9. The UE of claim 8, wherein the one or more processors are individually or collectively further operable to execute the code to cause the UE to:
include, in a channel state information reference signal resource indicator field of the first channel state information report, an index value indicating a first channel measurement resource of the plurality of channel measurement resources; and
include, in an interference measurement resource index field in the first channel state information report, an indication of an interference measurement resource index value indicating a first interference measurement resource of the plurality of interference measurement resources that corresponds to a first cross-link interference measurement, of the plurality of cross-link interference measurements, from which the one or more channel state information metrics are derived, wherein the first cross-link interference measurement corresponds to a smallest amount of measured cross-link interference of the plurality of cross-link interference measurements.

10. The UE of claim 8, wherein the one or more processors are individually or collectively further operable to execute the code to cause the UE to:
include, in a channel state information reference signal resource indicator field of the first channel state information report, an index value indicating a first channel measurement resource of the plurality of channel measurement resources; and
include, in a plurality of interference measurement resource index fields in the first channel state information report, a set of interference measurement resource index values indicating a first subset of interference measurement resources of the plurality of interference measurement resources that corresponds to a subset of cross-link interference measurements, of the plurality of cross-link interference measurements, from which the one or more channel state information metrics are derived, wherein each of the subset of cross-link interference measurements corresponds to smaller amounts of measured cross-link interference than a remainder of cross-link interference measurements of the plurality of cross-link interference measurements.

11. The UE of claim 8, wherein the one or more processors are individually or collectively further operable to execute the code to cause the UE to:
transmit the channel state information report via a physical uplink shared channel based at least in part on a quantity of the plurality of cross-link interference measurements, wherein the channel state information report comprises a second portion of a two-part channel state information report.

12. The UE of claim 8, wherein the one or more processors are individually or collectively further operable to execute the code to cause the UE to:
transmit the channel state information report via a physical uplink control channel based at least in part on the one or more channel state information metrics being based at least in part on a quantity of transport blocks corresponding to the channel state information report satisfying a threshold.

13. The UE of claim 1, wherein the one or more processors are individually or collectively further operable to execute the code to cause the UE to:
transmit capability information indicating a computational capability for processing the channel state information report, the computational capability based at least in part on a quantity of the set of channel measurement resources, a second quantity of the set of interference measurement resources, or both, wherein receiving the first control signaling is based at least in part on the computational capability.

14. A method for wireless communications at a user equipment (UE), comprising:
receiving first control signaling indicating a set of channel measurement resources comprising one or more channel measurement resources and a set of interference measurement resources comprising a plurality of interference measurement resources, the set of channel measurement resources and the set of interference measurement resources corresponding to a first channel state information report, and a channel measurement resource corresponding to the interference measurement resources of the plurality of interference measurement resources;
performing one or more channel state information measurements via the set of channel measurement resources according to the first control signaling;
performing a plurality of cross-link interference measurements via the set of interference measurement resources, wherein the plurality of interference measurement resources corresponds to a plurality of UEs; and
transmitting a channel state information report comprising one or more channel state information metrics, a channel state information metric based at least in part on the one or more channel state information measurements and one or more of the plurality of cross-link interference measurements.

15. The method of claim 14, further comprising:
deriving the one or more channel state information metrics based at least in part on a single channel state information measurement of the one or more channel state information measurements and one or more cross-link interference measurements of the plurality of cross-link interference measurements, wherein the set of channel measurement resources comprises a single channel measurement resource.

16. The method of claim 15, further comprising:
including, in an interference measurement resource index field in the first channel state information report, an indication of an interference measurement resource index value indicating a first interference measurement resource of the plurality of interference measurement resources that corresponds to a first cross-link interference measurement, of the plurality of cross-link interference measurements, from which the one or more channel state information metrics are derived, wherein the first cross-link interference measurement corresponds to a smallest amount of measured cross-link interference of the plurality of cross-link interference measurements.

17. The method of claim 15, further comprising:
including, in a channel state information reference signal resource indicator field of the first channel state information report, an index value indicating a first interference measurement resource of the plurality of interference measurement resources that corresponds to a first cross-link interference measurement, of the plurality of cross-link interference measurements, from which the one or more channel state information metrics are derived, wherein the first cross-link interference measurement corresponds to a smallest amount of measured cross-link interference of the plurality of cross-link interference measurements.

18. The method of claim 15, further comprising:
including, in a plurality of interference measurement resource index fields in the first channel state information report, a set of interference measurement resource index values indicating a first subset of interference measurement resources of the plurality of interference measurement resources that corresponds to a subset of cross-link interference measurements, of the plurality of cross-link interference measurements, from which the one or more channel state information metrics are derived, wherein each of the subset of cross-link interference measurements corresponds to smaller amounts of measured cross-link interference than a remainder of cross-link interference measurements of the plurality of cross-link interference measurements.

19. The method of claim 18, further comprising:
transmitting the channel state information report via a physical uplink shared channel based at least in part on the one or more channel state information metrics being based at least in part on the subset of cross-link interference measurements, wherein the channel state information report comprises a second portion of a two-part channel state information report.

20. A non-transitory computer-readable medium storing code for wireless communications, the code comprising instructions executable by one or more processors to:
receive first control signaling indicating a set of channel measurement resources comprising one or more channel measurement resources and a set of interference measurement resources comprising a plurality of interference measurement resources, the set of channel measurement resources and the set of interference measurement resources corresponding to a first channel state information report, and a channel measurement resource corresponding to the interference measurement resources of the plurality of interference measurement resources;
perform one or more channel state information measurements via the set of channel measurement resources according to the first control signaling;
perform a plurality of cross-link interference measurements via the set of interference measurement resources, wherein the plurality of interference measurement resources corresponds to a plurality of UEs; and
transmit a channel state information report comprising one or more channel state information metrics, a channel state information metric based at least in part on the one or more channel state information measurements and one or more of the plurality of cross-link interference measurements.
